(19) United States
(12) Patent Application Publication
(10) Pub. No.: US 2007/0274775 A1
(43) Pub. Date: Nov. 29, 2007

(54) Method For Joining Joint Parts To Hollow Profiles

(75) Inventor: Konrad Eipper, Rottenburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/581,794

(22) PCT Filed: Dec. 3, 2004
(86) PCT No.: PCT/EP04/13792

§ 371 Date: May 15, 2007

(30) Foreign Application Priority Data
Dec. 4, 2003 (DE) 103 56 533.7

(51) Int. Cl. F16B 17/00; B21D 39/04

(52) U.S. Cl. 403/345; 29/282

(57) ABSTRACT

The present invention relates to a method for joining at least one joint part (3), provided with a through-opening (4), to a hollow profile (1), the joint part (3) being pushed with its through-opening (4) onto the hollow profile (1) up to a joint point (2), and the hollow profile (1) being expanded at least at the joint point (2).

In order to improve the durability of the connection between joint part (3) and hollow profile (1), an adhesive (11) is arranged between an inner side (6) of the joint part (3) and an outer side (5) of the hollow profile (1) before the expansion in such a way that the adhesive (11) adheres to the inner side (6) and to the outer side (5) in the region of the joint point (2) after the expansion.

This application is a national phase application of International application PCT/EP2004/013792 filed Dec. 3, 2004 and claims the priority of German application No. 103 56 533.7, filed Dec. 4, 2003, the disclosures of which are expressly incorporated by reference herein.

### BACKGROUND AND SUMMARY OF THE INVENTION

The present invention relates to a method for joining at least one joint part, provided with a through-opening, to a hollow profile, and to a hollow body produced by the method.

DE 199 57 508 C1 discloses a device for joining joint parts to hollow profiles by means of fluidic internal high pressure. This device carries out a joining method in which the joint part is pushed with a through-opening onto the hollow profile up to a joint point and in which the hollow profile is partly expanded at the joint point by means of fluidic internal high pressure. The expansion of the hollow profile produces an interference fit between an inner side, facing the hollow profile, of the joint part and an outer side, facing the joint part, of the hollow profile, and this interference fit fixes the joint part to the hollow profile by friction grip. The hollow profile produced in this way therefore carries the joint part pushed onto it, which is fixed by the expansion of the hollow profile.

In the case of certain material configurations and/or material surfaces, and also during certain loads, such as, for example, vibrations and large temperature fluctuations, a situation may occur in which the interference fit between joint part and hollow body does not have sufficient fatigue strength. Furthermore, depending on material combination and/or environmental effects, corrosion may occur in the region of the joint point, a factor which may likewise impair the fatigue strength of the connection.

DE 101 58 731 A1 discloses a connecting element for hollow profiles which consists of sheet steel and two push-in connections for hollow profiles consisting of sheet steel. Those ends of the hollow profiles which are inserted into the push-in connections can be firmly connected to the connecting element by adhesive bonding or brazing or also by welding.

The present invention deals with the problem of specifying an improved embodiment for a method or for a hollow body provided with a joint part of the type mentioned at the beginning, this embodiment having in particular increased fatigue strength.

The present invention is based on the general idea of applying an adhesive in the region of the joint point in such a way that the adhesive adheres both to the inner side of the joint part and to the outer side of the hollow profile. The fixing between joint part and hollow body can be strengthened by this type of construction, since adhesion on account of the bonding effect of the adhesive is added to the friction grip of the interference fit. Furthermore, the adhesive can compensate for gaps, which may arise in the interference fit due to differences in geometry, and can thus improve the bond between joint part and hollow body. At the same time, the joint point can be more or less sealed by the introduced adhesive, a factor which prevents ingress of dirt into the joint point, that is to say between joint part and hollow body. As a result, certain corrosion protection can be achieved in the region of the joint point by means of the adhesive.

In a preferred embodiment of the method, the adhesive may be arranged in a recess which is present or is formed either on the inner side of the joint part or on the outer side of the hollow body before the expansion, this recess, during the expansion, more or less receding due to the deformation of the hollow body or of the joint part, so that it is completely or partly leveled after the expansion. That is to say that, after the expansion, the inner side and the outer side bear against one another over a surface area and the recess is more or less smoothed or flattened or evened out by deformation; at any rate the recess is no longer present or is scarcely present after the expansion. This at the same time causes the adhesive to be expelled from the recess during the leveling of the latter and to spread in the region of the joint point. This procedure has, inter alia, the advantage that the adhesive can be introduced into the recess before the joint part is pushed onto the hollow body, a factor which simplifies the sequence of the method. Furthermore, the positioning of the adhesive is predetermined by the recess, thereby resulting in better reproducibility for the spread of the adhesive during the expansion of the hollow body. The process reliability of the joining method can consequently be increased by this measure.

It goes without saying that the abovementioned features and the features still to be explained below can be used not only in the respectively specified combination but also in other combinations or on their own without departing from the scope of the present invention.

Preferred exemplary embodiments of the invention are shown in the drawings and are described in more detail below, the same designations designating identical or functionally identical or similar components.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows a greatly simplified longitudinal section through a hollow profile in the region of a joint point before expansion in accordance with an embodiment of the present invention,

FIG. 2 shows a sectional view as in FIG. 1 but after the expansion,

FIG. 3 shows a sectional view as in FIG. 2 but in another embodiment,

FIG. 4 shows a sectional view as in FIG. 2 but in a further embodiment.

### DETAILED DESCRIPTION

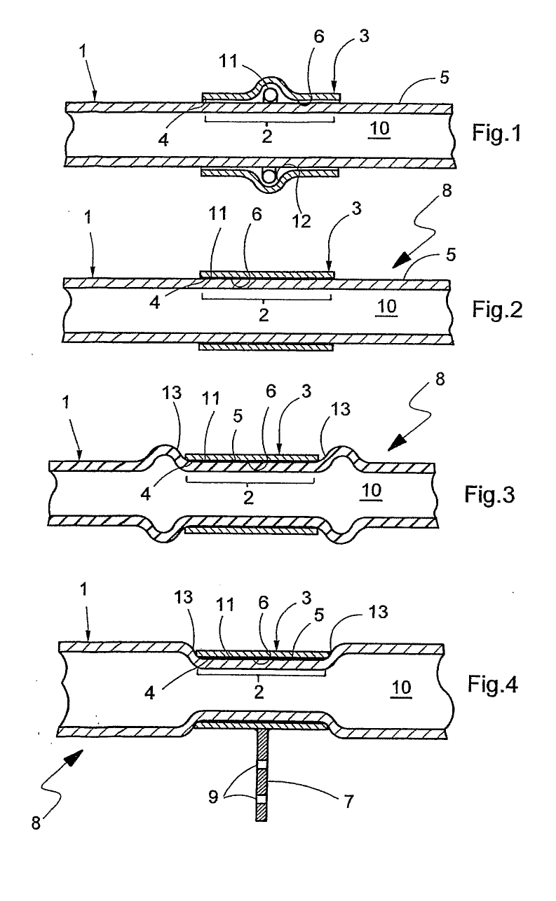

According to FIG. 1, a hollow profile 1, in its axial longitudinal direction, has at least one joint point 2, which is identified here by brackets. At this joint point 2, a joint part 3 is to be fastened to the hollow profile 1. For this purpose, the joint part 3 is provided with a through-opening 4, which is dimensioned in such a way that the joint part 3 can be pushed with its through-opening 4 onto the hollow profile 1. As a rule, in an initial state shown in FIG. 1, there is therefore a radial clearance between an outer side 5 of the hollow profile 1 and an inner side 6 of the joint part 3.

The hollow profile 1 is, for example, a member in a supporting frame structure of a motor vehicle, this member having to be firmly connected within this supporting frame structure to other components of this supporting frame structure. In order to simplify the incorporation of the hollow profile 1 in the supporting frame structure, at least the one joint part 3 is now fastened to the hollow profile 1. This joint part 3 can be designed in an especially simple manner in such a way that the incorporation of the hollow profile 1 in said supporting frame structure is simplified as a result. For example, the joint part 3 according to FIG. 4 can be provided with a fastening section 7, by which a combination 8 formed from the hollow body 1 and the joint part 3 joined thereto can be fastened to another component, in particular the supporting frame structure. For example, the fastening section 7 is designed here as a flange, which may already be provided with through-openings 9, which permit, for example, a screwed connection to another component.

Alternatively, the joint part 3 itself could be an integral part of the supporting frame structure.

The joining, that is to say the securing, of the joint part 3 to the hollow profile 1, is achieved by expanding the hollow profile 1, at least in the region of the joint point 2. This expansion is preferably effected by means of an internal high pressure, what is referred to as internal high pressure forming, produced in the interior 10 of the hollow profile 1. The internal high pressure is expediently generated hydraulically. To this end, the hollow profile 1 is connected to a pressure-generating device (not shown here) which generates the requisite high forming pressure in the interior 10 of the hollow profile 1. For partial expansion of the hollow profile 1 specifically at the respective joint point 2, a special lance can be used which enables the internal high pressure to be generated only in the region of the joint point 2, whereas the adjacent sections of the hollow profile 1 are isolated from the internal high pressure. A device for the partial expansion of the hollow profile 1 is explained in more detail, for example, in DE 199 57 508 C1 mentioned at the beginning, the disclosed content of which, by express reference, is hereby added to the content of the present invention.

The joining method according to the invention works as described in the embodiment which follows:

According to FIG. 1, the joint part 3 is pushed with its through-opening 4 onto the hollow profile 1, to be precise up to the joint point 2. Before the expansion operation, an adhesive 11 is arranged between the inner side 6 and the outer side 5. The adhesive 11 preferably extends in an annular manner in the circumferential direction of the hollow profile 1, so that it essentially fully encloses the hollow profile 1.

In the special embodiment shown here, a recess 12 which serves to accommodate the adhesive 11 is formed on the inner side 6 of the joint part 3. Here, the recess 12 likewise fully extends in an annular manner in the circumferential direction. In the initial state according to FIG. 1, the recess 12 is present in the correspondingly produced joint part 3, that is to say before the expansion of the hollow profile 1. The recess 12 enables the adhesive 11 to be arranged in the recess 12 before the joint part 3 is pushed onto the hollow profile 1, so that the joint part 3 can already be pushed with adhesive 11 arranged in the recess 12 onto the hollow profile 1. This simplifies the process sequence, since the joint parts 3 can already be prepared beforehand with the adhesive 11.

Although the recess 12 in the preferred embodiment shown here is formed on the inner side 6 of the joint part 3, the recess 12 in another embodiment may also be formed on the outer side 5 of the hollow profile 1. Furthermore, it is in principle possible to provide more than one recess 12 and to provide them with adhesive 11.

The adhesive 11 may in principle be applied in the form of an adhesive bead or introduced into the recess 12. A configuration may also be expedient in which the adhesive 11 is prepared in the form of a solid, which can be introduced into the recess 12 in an especially simple manner. A solid adhesive 11 can be manipulated in an especially simple manner. In particular, a solid adhesive 11 can be designed in such a way that it essentially does not adhere in its solid initial state, a factor which additionally simplifies the manipulation.

After the joint part 3 has been pushed onto the hollow profile 1 and positioned at the joint point 2 provided, and after the adhesive 11 has been arranged between the inner side 6 and the outer side 5, that is to say in the recess 12 in this case, which is expediently already effected before the joint part 3 is pushed onto the hollow body 1, the hollow body 1 can now be expanded at least in the region of the joint point 2, e.g. by means of internal high pressure. The outer side 5 is pressed together with the inner side 6 by the expansion of the hollow profile 1 at least in the region of the joint point 2. At the same time, the adhesive 11 arranged in between is thereby pressed inside the joint zone 2 between inner side 6 and outer side 5, as a result of which it spreads largely within the entire joint zone 2 and consequently wets both the inner side 6 and the outer side 5 over as large an area as possible. The adhesive 11 can then adhere to the inner side 6 and the outer side 5.

In the case of a curable adhesive, the adhesion is not effected until after the adhesive 11 has set, which is effected with a more or less large time delay after the expansion operation. Certain adhesives 11, preferably adhesives 11 designed as solid bodies, are configured in such a way that their setting process has to be initiated by pressure and/or temperature, the setting process, once initiated, then taking place automatically until the adhesive 11 is entirely set. The method parameters for the joining operation may now preferably be adapted to such adhesives 11 in such a way that, during the expansion of the hollow profile 1, temperatures and/or pressures which initiate the setting process can be produced in the adhesive 11. In this way, additional method steps can be saved, which otherwise would have to be carried out after the expansion for initiating the setting process.

According to FIG. 2, the hollow profile 1 can also be expanded on both sides of the joint point 2, so that no jump in cross section occurs in the region of the joint point 2. Alternatively, as already explained, the hollow profile 1 can also be partly expanded specifically only in the region of the joint point 2.

In the embodiments in FIGS. 3 and 4, the hollow profile 1 is expanded in such a way that additional or continuing expansion of the hollow profile 1 results directly adjacent to the joint part 3. In this way, the hollow profile 1 can be provided with a step 13 at least on one side of the joint part 3, this step 13 coming to bear laterally against the joint part 3 after the expansion operation. This also results in positive locking for the longitudinal positioning of the joint part 3 on the hollow profile 1. In the embodiment shown here, such a step 13 is formed on each side of the joint part 3. Likewise possible is an embodiment in which such a step 13 is provided only on one side of the joint part 3.

In the embodiment according to FIG. 3, the hollow profile 1 is additionally expanded only in a relatively small section which adjoins the joint part 3 in order to form the respective step 13. In this way, the hollow profile 1 is provided with a type of annular bead which, with the step 13, axially fixes the joint part 3 at least in the longitudinal direction.

In contrast thereto, the expansion in the variant according to FIG. 4 is effected in such a way that the hollow profile 1 is expanded over a larger longitudinal section, adjoining the joint part 3, to the extent that the outer cross-sectional area of the hollow profile 1 for forming the step 13 is larger than the inner cross-sectional area of the joint part 3 in its through-opening 4. In this way, a recessed receptacle, as it were, is created for the joint part 3, and this receptacle axially fixes the joint part 3.

As can be seen from FIGS. 2 to 4, the expansion of the hollow profile 1 in the region of the joint point 2 in the preferred embodiment shown here also deforms the joint part 3, to be precise in such a way that the recess 12 formed therein is leveled. In this way, the inner side 6 bears against the outer side 5 over as large an area as possible over the entire joint point 2. The quantity of adhesive 11 introduced is expediently dimensioned in such a way that the adhesive 11 can spread if possible over the entire joint point 2, but without producing an undesirably high outflow from the through-opening 4 at the longitudinal ends of the joint part 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-7. (canceled)

8. A method for joining at least one joint part, comprising the steps of:
inserting a hollow profile into a through-opening of a joint part up to a joint point;
providing an adhesive between an inner side of the joint part and an outer side of the hollow profile at the joint point;
expanding the hollow profile at least at the joint point,
wherein
the adhesive is provided in an annular recess formed on at least one of the inner side of the joint part and on the outer side of the hollow profile, and
the recess is configured such that during the expansion step the recess is essentially leveled and the adhesive is displaced over an area of the joint point.

9. The method as claimed in claim 8, wherein
the adhesive is fully encloses a circumference of the hollow profile.

10. The method as claimed in claim 8, wherein
the adhesive is provided between the joint part and the hollow profile before the hollow profile is inserted into the joint part, and
the adhesive is in a solid form when provided between the hollow profile and the joint part.

11. The method as claimed in claim 8, wherein
the hollow profile is also expanded directly adjacent to the joint part such that after expansion, at least on one side of the joint part a step bears laterally against the joint part.

12. The method as claimed in claims 8 wherein
the hollow profile is expanded by application of internal high pressure.

13. A hollow profile joint, comprising:
a hollow profile;
a joint part; and
an adhesive.
wherein
the hollow profile is located in a through-opening of the joint part at a joint point, and is expanded at least at the joint point and adjacent to the joint part such that an annular bead-shaped step formed on the hollow profile bears against the joint part, and
the adhesive is located between an inner side of the joint part and an outer side of the hollow profile at the joint point.

14. The hollow profile as claimed in claim 13, wherein the joint part has a fastening section arranged to permit fastening of the combined joint part and hollow profile to another component.
